(19) United States
(12) Patent Application Publication
(10) Pub. No.: US 2017/0308532 A1
(43) Pub. Date: Oct. 26, 2017

(54) NETWORK SOURCE FEATURE BASED CONTENT GENERATION

(71) Applicant: LinkedIn Corporation, Mountain View, CA (US)

(72) Inventors: Keith Wai Kit Tsang, Fremont, CA (US); Qiang Zhu, Sunnyvale, CA (US); Songtao Guo, Cupertino, CA (US); Aviv Eyal, San Jose, CA (US); Sui Yan, Sunnyvale, CA (US)

(21) Appl. No.: 15/133,997

(22) Filed: Apr. 20, 2016

(51) Int. Cl. G06F 17/30; G06F 17/22; H04L 29/08

(52) U.S. Cl. CPC G06F 17/3053; H04L 67/02; G06F 17/2235; G06F 17/30873

(57) ABSTRACT

A system and method for generating content based on network source features are provided. In example embodiments, a request for a landing page that shows a display of one or more electronic documents is received. The source of the landing page and the one or more electronic documents is analyzed to determine page view correlation data and selection correlation data. The page view correlation data and selection correlation data is used to generate rank data for the electronic documents. The electronic documents are sorted according to the rank data and a display of the electronic documents in sorted order is provided.

### TECHNICAL FIELD

Embodiments of the present disclosure relate generally to content generation and, more particularly, but not by way of limitation, to network source feature based content generation.

### BACKGROUND

Content can be generated for a page based on data in the referring page. For example, a user may enter a search string on a search site webpage and a results webpage may be populated with results content based on the search string. However, this approach requires that the user generally know the content for which they are searching. For example, a user that is unfamiliar with a website platform may not know how to navigate the website platform or may not know how to find relevant content. As such, pages navigated to may or may not have content relevant to the user.

### BRIEF DESCRIPTION OF THE DRAWINGS

Various ones of the appended drawings merely illustrate example embodiments of the present disclosure and cannot be considered as limiting its scope.

FIG. 1 is a network diagram depicting a network system having a client-server architecture configured for exchanging data over a network with a source feature content generator system, according to example embodiments.

FIG. 2 is a block diagram depicting various functional components of a source feature content generator, which is provided as part of the network system, according to example embodiments.

FIG. 3 is a block diagram depicting source channels, source attributes, electronic documents, and a landing page, according to example embodiments.

FIG. 4 is a block diagram depicting rank data and associated electronic documents, according to example embodiments.

FIG. 5 is a flow chart illustrating a method for generating page view correlation data, according to an example embodiment.

FIG. 6 is a flow chart illustrating a method for generating selection correlation data, according to an example embodiment.

FIG. 7 is a flow chart illustrating a method for generating rank data and landing page display content, according to an example embodiment.

FIG. 8A is a user interface diagram showing a source channel implemented as a webpage, according to an example embodiment.

FIG. 8B is a user interface diagram showing a landing page with electronic documents, according to an example embodiment.

FIG. 9 is a diagrammatic representation of a machine in the example form of a computer system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the disclosure. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

In various example embodiments, an approach for network source feature content generation may be implemented by initially receiving a request for a landing page. The referring page may be identified as a source channel. Additionally, other features such as user features (e.g., premium or free user) or portions of the source channel may be associated with the source channel. One or more electronic documents, such as result pages, may be used to populate the landing page. For example, the source channel may be a search page, the landing page may be a page to display search results, and the electronic documents may each be a webpage search result.

The landing page sorts the electronic documents for display as search results using rank data. Rank data may be generated based on page view correlation data and selection correlation data. Page view correlation data may be determined, in some embodiments, by ascertaining how many page views of a search result originated from the source channel. Selection correlation data may be determined, in some embodiments, by ascertaining how many source channels of the available search channels have selected a given search result in the page. In some embodiments, both page view correlation data and selection correlation data are determined from analyzing past historical data of correspondences between the source channels and the search result.

In some embodiments, the request for the landing page is received, and in response to receiving the request, rank data is generated and used to populate search results (e.g., electronic documents, request results) in the landing page, in a on-the-fly dynamic manner. In some embodiments, rank data is generated for each source channel and stored in a database for later use. In those embodiments, when a user requests a landing page, the source channel of the user is identified and pre-generated rank data for the identified source channel is retrieved from the database and used to populate the search results.

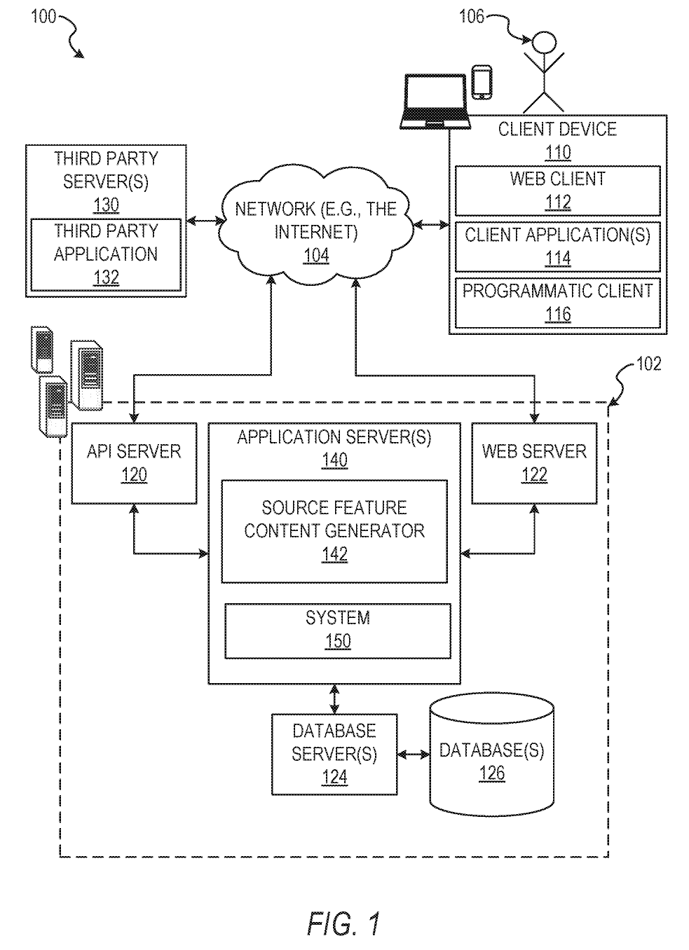

With reference to FIG. 1, an example embodiment of a high-level client-server-based network architecture 100 is shown. A networked system 102, in the example form of a network-based publication system, provides server-side functionality via a network 104 (e.g., the Internet or a wide area network (WAN)) to one or more client devices 110. In some implementations, a user 106 interacts with the networked system 102 using the client device 110. FIG. 1 illustrates, for example, a web client 112 (e.g., a browser, such as the INTERNET EXPLORER® browser developed by MICROSOFT® Corporation of Redmond, Wash. State), client applications 114, and a programmatic client 116 executing on the client device 110. The client device 110 includes the web client 112, the client application(s) 114, and the programmatic client 116 alone, together, or in any suitable combination. Although FIG. 1 shows one client device 110, in other implementations, the network architecture 100 comprises multiple client devices.

In various implementations, the client device 110 comprises a computing device that includes at least a display and communication capabilities that provide access to the networked system 102 via the network 104. The client device 110 comprises, but is not limited to, a remote device, work station, computer, general purpose computer, Internet appliance, hand-held device, wireless device, portable device, wearable computer, cellular or mobile phone, Personal Digital Assistant (PDA), smart phone, tablet, ultrabook, netbook, laptop, desktop, multi-processor system, microprocessor-based or programmable consumer electronic system, game console, set-top box, network Personal Computer (PC), mini-computer, and so forth. In an example embodiment, the client device 110 comprises one or more of a touch screen, accelerometer, gyroscope, biometric sensor, camera, microphone, Global Positioning System (GPS) device, and the like.

The client device 110 communicates with the network 104 via a wired or wireless connection. For example, one or more portions of the network 104 comprise an ad hoc network, an intranet, an extranet, a Virtual Private Network (VPN), a Local Area Network (LAN), a wireless LAN (WLAN), a WAN, a wireless WAN (WWAN), a Metropolitan Area Network (MAN), a portion of the Internet, a portion of the Public Switched Telephone Network (PSTN), a cellular telephone network, a wireless network, a Wireless Fidelity (WI-FI®) network, a Worldwide Interoperability for Microwave Access (WiMax) network, another type of network, or any suitable combination thereof.

In some example embodiments, the client device 110 includes one or more applications (also referred to as “apps”) such as, but not limited to, web browsers, book reader apps (operable to read e-books), media apps (operable to present various media forms including audio and video), fitness apps, biometric monitoring apps, messaging apps, electronic mail (email) apps, and publication site apps (also referred to as “publishing client apps”). In some implementations, the client application(s) 114 include various components operable to present information to the user 106 and communicate with the networked system 102. In some embodiments, if the publishing client application is included in the client device 110, then this application is configured to locally provide the user interface and at least some of the functionalities, and to communicate with the networked system 102, on an as needed basis, for data or processing capabilities not locally available (e.g., access to a database of items available for sale, to authenticate a user, to verify a method of payment). Conversely, if the publishing client application is not included in the client device 110, the client device 110 can use its web browser to access a publication website (or a variant thereof) hosted on the networked system 102.

The web client 112 accesses the various systems of the networked system 102 via the web interface supported by a web server 122. Similarly, the programmatic client 116 and client application(s) 114 access the various services and functions provided by the networked system 102 via the programmatic interface provided by an Application Program Interface (API) server 120. The programmatic client 116 can, for example, be an application generated and distributed by the developers of the source feature content generator 142 to programmatically interface with the source feature content generator 142.

Users (e.g., the user 106) comprise a person, a machine, or other means of interacting with the client device 110. In some example embodiments, the user is not part of the network architecture 100, but interacts with the network architecture 100 via the client device 110 or another means. For instance, the user provides input (e.g., touch screen input or alphanumeric input) to the client device 110 and the input is communicated to the networked system 102 via the network 104. In this instance, the networked system 102, in response to receiving the input from the user, communicates information to the client device 110 via the network 104 to be presented to the user. In this way, the user can interact with the networked system 102 using the client device 110.

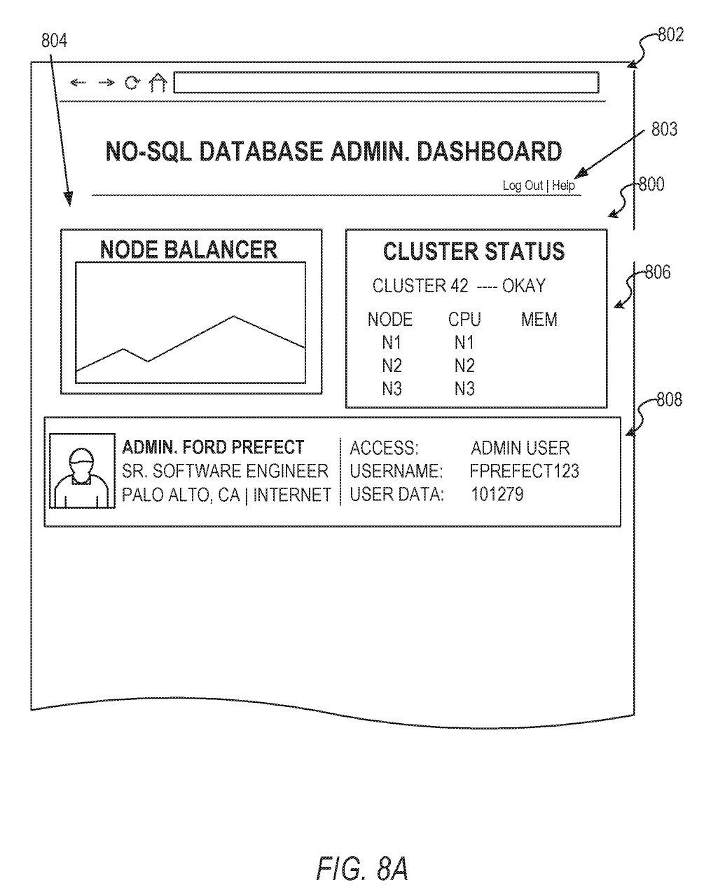

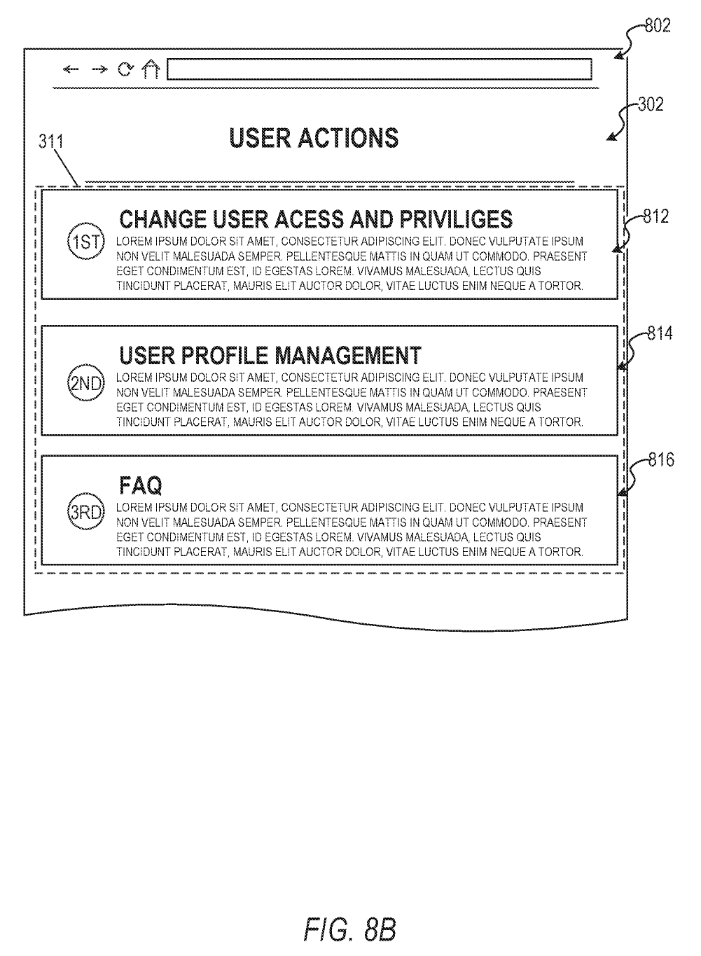

The API server 120 and the web server 122 are coupled to, and provide programmatic and web interfaces respectively to, one or more application server(s) 140. The application server(s) 140 can host one or more source feature content generator 142 and a system 150, each of which comprises one or more modules or applications and each of which can be embodied as hardware, software, firmware, or any combination thereof. The system 150 can be a primary application that receives source feature content generation services from the source feature content generator 150. One example of a system may be a database administrative dashboard, as illustrated in FIG. 8A and discussed in further detail below. The application server(s) 140 are, in turn, shown to be coupled to one or more database server(s) 124 that facilitate access to one or more information storage repositories or database(s) 126. In an example embodiment, the database(s) 126 are storage devices that store information, such as electronic documents, rank data, page view correlation data, and selection correlation data, to be used by the source feature content generator 142.

Additionally, a third party application 132, executing on third party server(s) 130, is shown as having programmatic access to the networked system 102 via the programmatic interface provided by the API server 120. For example, the third party application 132, utilizing information retrieved from the networked system 102, supports one or more features or functions on a website hosted by the third party, such as hosted content that can be used to populate a landing page, as discussed in further detail below.

In some implementations, the source feature content generator 142 provides functionality to receive requests for a landing page, the requests being caused by and received from the client device 110. The source feature content generator 142 may further provide functionality to generate rank data from page view correlation data and selection correlation data and to use the rank data to populate the landing page with electronic documents (e.g., request results), which may be sorted using the rank data.

Further, while the client-server-based network architecture 100 shown in FIG. 1. employs a client-server architecture, the present inventive subject matter is, of course, not limited to such an architecture, and can equally well find application in a distributed, or peer-to-peer, architecture system, for example. The various systems of the applications server(s) 140 (e.g., the source feature content generator 142 and the system(s) 150) can also be implemented as standalone software programs, which do not necessarily have networking capabilities.

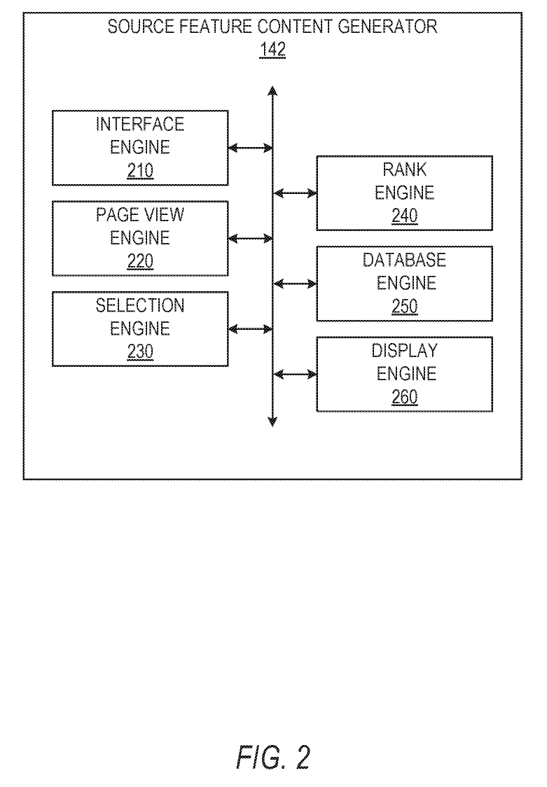

FIG. 2 is a block diagram showing components provided within the source feature content generator 142, according to some embodiments. In various example embodiments, the source feature content generator 142 comprises an electronic document management system. The source feature content generator 142 can be hosted on dedicated or shared server machines that are communicatively coupled to enable communications between the server machines. The components themselves are communicatively coupled (e.g., via appropriate interfaces) to each other and to various data sources, so as to allow information to be passed between the applications or so as to allow the applications to share and access common data. Furthermore, the components access one or more database(s) 126 via the database server(s) 124. As such, the source feature content generator 142 provides a number of content retrieval, landing page generator, and rank data mechanisms.

To this end, the source feature content generator 142 comprises an interface engine 210, a page view engine 220, a selection engine 230, a rank engine 240, a database engine 250, and a display engine 260, according to some embodiments.

The interface engine 210 is responsible for interfacing with servers such as the third-party server(s) 130 or with the client device 110. The page view engine 220 is responsible for determining the page view correlation between electronic documents and source channels. For example, the page view engine 220 may identify an electronic document, such as a webpage, and determine how many page views of the electronic document were caused or referred to by different source channels.

A source channel is a source that referred the user to the landing page or referred the user to the electronic document under consideration. For example, a user may be viewing a source webpage (e.g., source channel), click a hyperlink within the source webpage, and navigate directly to a destination webpage (e.g., electronic document). Further, a source channel may be an originating source to the electronic document by way of a landing page. For example, a user may be viewing the source webpage, and may click a hyperlink which navigates the user to a landing page that shows a plurality of electronic documents for selection. From the landing page, the user can click on a selected electronic document and be taken to the electronic document. In the above examples, a page view may be a direct link from a given source channel to a given electronic document, or a page view may be a link from a source channel, to a landing page, then to the electronic document.

It is to be appreciated that the landing page may show the actual plurality of electronic documents, for example through frames (e.g., iframes), or the landing page may show representations of the electronic documents as a plurality of hyperlinks that when selected (e.g., clicked) take the user to the selected electronic document.

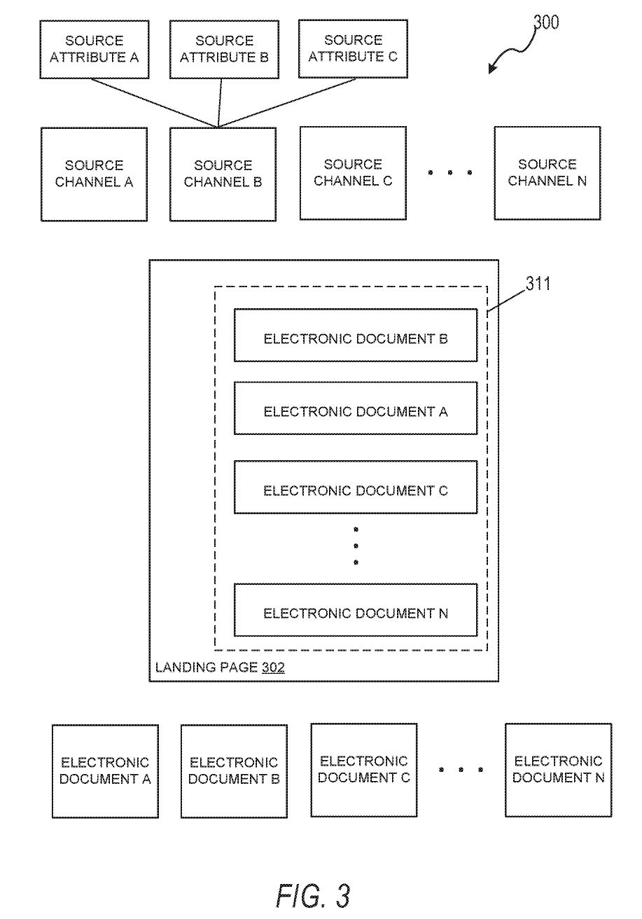

The page view engine 220 is further configured to identify the page views for electronic documents per source channels and generate page view correlation data as discussed in further detail below with reference to FIGS. 3-5.

The selection engine 230 is responsible for determining selection correlation data, according to some embodiments. Selection correlation data is identified by determining how many source channels are available for a given electronic document, and determining how many of those available source channels have users that selected the electronic document in the past. The number of the available source channels that have selected a selected electronic document is generated by the selection engine 230 as selection correlation data.

The rank engine 240 is responsible for generating rank data for the electronic documents. In particular, the rank engine 240 may use the page view correlation data for a given electronic document and the selection correlation data for the electronic document and generate the rank data for sorting the electronic document with respect to other electronic documents.

The database engine 250 is responsible for managing access to databases, such as the database 126. In some embodiments, the rank data is stored for retrieval in the database 126 using the database engine 250. Once the rank data is stored in the database 126, when a user lands on a page, the referrer page may be identified as the source channel, and the rank data that corresponds to that source channel may be retrieved from the database 126 to generate request results, as explained in further detail below.

The display engine 260 is responsible for generating user interfaces for display on a client device. For example, the display engine 260 may interface with the database engine 250 to retrieve rank data, retrieve or identify electronic documents for display, and sort the electronic documents for display according to the rank data, and then generate a user interface display comprising the sorted electronic documents for transmission to or display on a user interface.

FIG. 3 is a block diagram 300 depicting source channels A-N, source attributes, electronic documents, and a landing page 302, according to example embodiments. The landing page 302 is a page, such as a webpage, that the source channels A-N link to through a network link, such as a hyperlink. As discussed, the plurality of source channels may correspond to referring webpages or other sources, such as a page generated by the client application(s) 114. For example, source channel A may be a webpage that has a network link, such as a hyperlink, that when clicked, directs the user 106 to the landing page 302. Though only four source channels are illustrated in FIG. 3, it is to be appreciated that any number “N” of source channels may be used for the approaches disclosed herein.

Each source channel may further correspond to one or more source attributes. A source attribute is an attribute of the source channel which may be used as a further dimension in generating page view correlation data, selection correlation data, or rank data. For example, with reference to source channel B, if source channel B is an administrative dashboard page, source attribute A may indicate whether the user of the dashboard is a free user or a premium user, source attribute B may indicate whether that user is a heavy user or a light user, and source attribute C may define the access privileges of that user. The source channel, as well as any associated source attributes, may be used to further refine rank data, as described in further detail below with reference to FIG. 8A.

Electronic documents A through N are content documents or executable documents that comprise content for a user to view or use, respectively. In some embodiments, the electronic documents comprise markup language (e.g., HTML) to display the content. In some embodiments, the electronic documents comprise executable code, such as scripts or front-end/back-end database calls for a web service.

As illustrated in FIG. 3, the landing page 302 comprises a display area 311 that shows the electronic documents in a sorted order according to rank data. As an illustrated example, assume a user such as user 106 is viewing source channel A as a webpage. The user 106 may click on a hyperlink in source channel A to navigate to landing page 302. Back-end processes performed by the source feature content generator 142 may generate rank data and provide the electronic documents in sorted order as follows. First, the page views for electronic document A per source channel are determined. In particular, the number of page views of electronic document A referred from source channel A is determined, the number of page views of electronic document A referred from source channel B is determined, the number of page views of electronic document A referred from source channel C is determined, and so on, until the number of page views of electronic document A referred from the last source channel, source channel N, is determined.

Page views for electronic document B and electronic document C may be determined in the same manner. In general, the page view for each electronic document are determined by analyzing how many page views for a given electronic document were referred by, originated from, or otherwise caused by code in each of the source channels. The page view correlation data for each electronic document may then be stored as page view correlation data in the database 126 or kept in memory for further processing to generate rank data.

Next, selection correlation data may be determined by first determining how many source channels are available. That is, for example, how many possible webpages refer or link to the electronic documents A-N. The total number of available source channels may be determined by analyzing historical network traffic data for the system 150. The network traffic data may comprise the number of page views and other network data for the system 150. The historical network traffic data may be stored in the database 126 for retrieval.

Continuing the example, with reference to FIG. 3, there are four source channels available, source channels A-N. Thus, the total number of source channels available or webpages available that refer to the landing page 302 is four. Then, the selection engine 230 determines how many of the available source channels have selected a given electronic document in the past. For example, if electronic document A is a frequently asked questions (FAQ) page, selection engine 230 ascertains how many users from each of source channels A-N have historically selected electronic document A, which is the FAQ page. The number of source channels that have selected a given electronic document is stored or otherwise identified as historical selection criteria.

The historical selection criteria and the total number of source channels available may be combined to generate selection correlation data, as explained in further detail below.

Further, the page view correlation data and the selection correlation data may be combined to generate rank data for each of the electronic documents A-N. The rank data for each of the electronic documents A-N may then be used to generate a sorted display of request results in the display area 311.

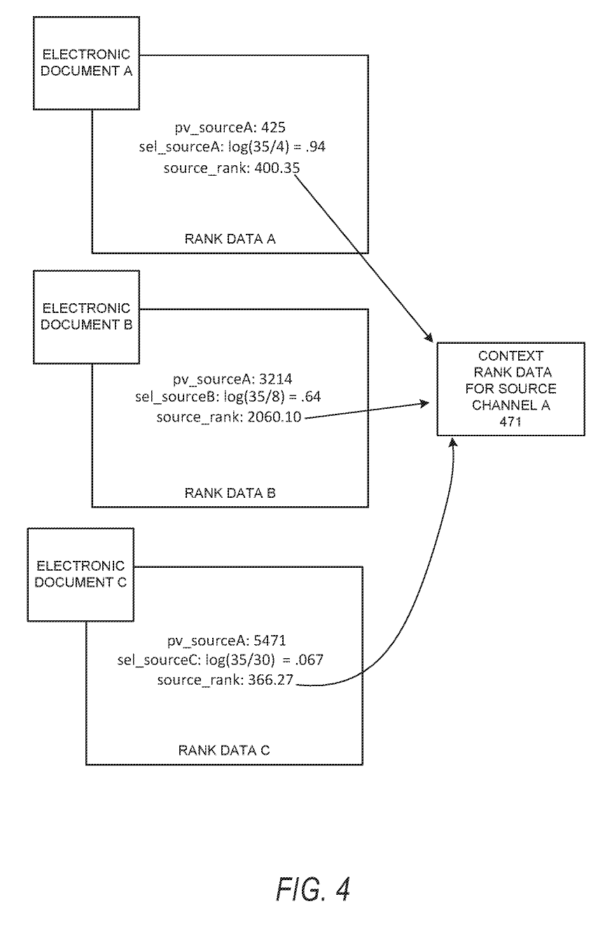

FIG. 4 shows an illustrative example of the electronic documents A-C and corresponding rank data. For the example shown in FIG. 4, a user on source channel A has navigated to the landing page 302 and each of rank data A, rank data B, and rank data C is generated with respect to the user from source channel A. In other words, as explained in further detail below, the page view correlation data determines how many page views of the electronic document under consideration were caused by a user from source channel A. In contrast, selection correlation data macroscopically analyzes relevance, for example by determining, of the available source channels, how many source channels directed traffic to the electronic document under consideration.

With reference to rank data A, as illustrated, rank data may include the page view correlation data, which is illustrated as “pv_sourceA”; the selection correlation data, which is illustrated as “sel_sourceA”; and source rank data, which is illustrated as “source_rank”. Source rank data for each of the electronic documents may be collectively used as rank data to sort the electronic documents for display in the display area 311.

Continuing the example, with reference to electronic document A, page view correlation data (“pv_sourceA”) may be determined as follows. The page view engine 220 determines how many page views of electronic document A were referred from or originated from source channel A. As illustrated in FIG. 4, there are 425 page views of electronic document A that were referred from source channel A.

Again, with reference to electronic document A, selection correlation data (“sel_sourceA”) has an output of 0.94. The selection correlation data may first be computed by identifying how many source channels are available.

In FIG. 4, with reference to rank data A, the number 35 is the total number of source channels available. For example, there may be 35 referring webpages that have a hyperlink to the landing page 302 or electronic document A. Next, the value of the historical selection criteria is determined. The historical selection criteria corresponds to how many users of the source channels have historically arrived at electronic document A. Applied here, as illustrated, four users of the 35 source channels have arrived at electronic document A. In other words, there are 35 available source channels and only four users on the available 35 source channels have historically clicked links to arrive at electronic document A. Thus, historical selection criteria correspond to how narrow or broad the relevance of electronic document A is to the 35 source channels.

Continuing the example, to generate selection correlation data the total number of available source channels is weighted against the historical selection criteria. In some embodiments, the base 10 log of the ratio of the total number of source channels to the historical selection criteria is determined and stored as selection correlation data (e.g., log10(35/4)=0.94).

The rank engine 240 may then combine the page view correlation data of electronic document A and the selection correlation data of electronic document A to generate the source rank data. In some embodiments, the page view correlation data and the selection correlation data are combined through multiplication, and the output of the multiplication is stored as the source rank data (e.g., 425*0.94=400.35).

Similarly, electronic document B is illustrated with corresponding rank data B. With reference to page view correlation data in rank data B (“pv_sourceA: 3214”), the page view engine 220 determines how many page views of electronic document B were caused or referred by source channel A; or in other words, how many people were on the source channel A webpage and clicked the hyperlink to arrive at electronic document B. As illustrated, the number of users on source channel A that selected or arrived at electronic document B is 3,214.

Similarly, selection correlation data is determined in the same way as it was for rank data A. There are 35 available source channels, and of the users on the available 35 source channels, eight have in the past selected electronic document B, giving selection correlation data of 0.64. Source rank data is then generated for rank data B by multiplying 3,214 times 0.64 to generate 2,060.10, which may be stored as source rank data for electronic document B.

Similarly, the page view correlation data for electronic document C and rank data C may be generated. Accordingly, the number of page views of electronic document C from users on source channel A is 5,471. Selection correlation data for electronic document C is generated in the same way as for electronic document B and electronic document A. Again, there are 35 available source channels or ways to arrive at electronic document C (e.g., through direct linking to electronic document C or by way of one or more intermediary pages, such as landing page 302). Of those available 35 source channels, users on 30 of them (e.g., one user from each of the 30) have selected or navigated to electronic document C. Notably, the number 30 is much higher than the numbers of users reflected in the other rank data A and B, which are four and eight respectively. Also notably, the page view number of rank data C is 5,471. Thus, rank data C or electronic document C may correspond to a popular document as indicated by the number of page views, but also a document that everybody selects as indicated by the 30. As users on 30 of the available source channels navigated to electronic document C, electronic document C may correspond to a general FAQ page, and it may not be highly relevant or customized per each of the source channels.

Once rank data has been generated for all of the electronic documents or corresponding source rank data has been generated, the source rank data for each electronic document may be stored as context rank data for source channel A 471. The context rank data for source channel A 471 may be stored in the database 126 pre-generated context rank data for later retrieval when it is determined that source channel A is under consideration (e.g., due to a user landing on landing page 302 from source channel A). Context rank data for users arriving from different source channels (e.g., source channel B, source channel C) may be determined the same way as the rank data for a user arriving from source channel A was determined in FIG. 4.

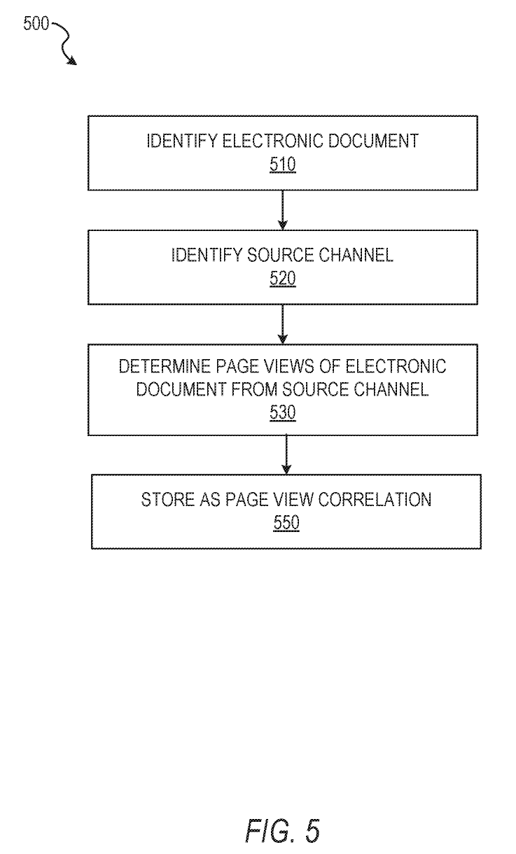

FIG. 5 is a flow chart 500 illustrating a method for generating page view correlation data, according to an example embodiment. At operation 510, the page view engine 220 identifies an electronic document under consideration. For example, the electronic document under consideration may be electronic document A. At operation 520, the page view engine 220 identifies the source channel from which the user 106 navigated to the landing page 302. For example, if the user 106 was on source channel A and clicked on a hyperlink to navigate to the landing page 302, the source channel identified at operation 520 would be source channel A.

At operation 530, the page view engine 220 determines the number of page views from the source channel. For instance, the page view engine 220 may determine the page views for each of the electronic documents from the identified source channel. Continuing the example, if the source channel is source channel A, the numbers of page views from source channel A are 425, 3,214, and 5,471, for electronic documents A, B, and C, respectively.

On the other hand, for example, if the user on the landing page came from source channel B, the historical data may be accessed to determine that source channel B has referred users to electronic document A 970 times, referred users to electronic document B 874 times, and referred users to electronic document C 44 times. Notably, for example, the 970 page views of electronic document A from source channel B (not depicted in FIG. 4) is different from the 425 page views of electronic document A from source channel A, the latter of which is illustrated in FIG. 4 in rank data A. It is to be appreciated that the page view engine 220 is configured to determine page views for each electronic document from each source channel, respectively, according to some embodiments.

At operation 550, the page view correlation data is stored in the database 126 via the database engine 250. Alternatively, at operation 550, page view correlation data may be transferred to the rank engine 240 to generate rank data dynamically in response to a user landing on the landing page 302.

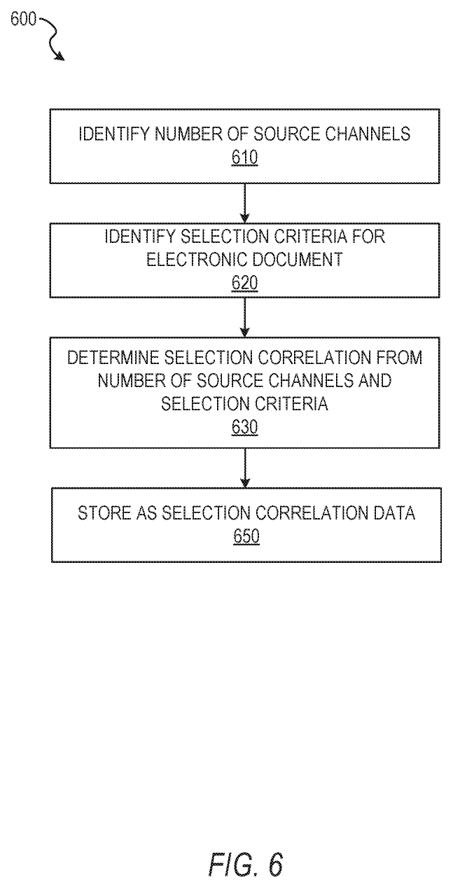

FIG. 6 is a flow chart 600 illustrating a method for generating selection correlation data, according to an example embodiment. At operation 610, the number of available source channels is identified. For example, with reference to the example of FIG. 4, there were 35 source channels or 35 ways to arrive at the landing page 302.

At operation 620, the selection engine 230 identifies the historical selection criteria for a given electronic document. For example, with reference to FIG. 4, in rank data A, there are 35 available source channels and the historical selection criteria which corresponds to the number of users that have selected electronic document A historically is four. in some embodiments, the database 126 comprises historical data describing which users have landed on a landing page and selected which electronic document. This historical data may be retrieved through a database engine or a database server such as the database server 124 to determine selection criteria, Similarly, the database 126 may also comprise selection correlation data, such as which channels are available.

At operation 630, the selection correlation may be generated by modifying or combining the historical selection criteria and the number of source channels using ratios or other mathematical operators, In some embodiments, the ratio comprises the total number of source channels in the numerator and the selection criteria and the denominator. Further, in some embodiments, the selection correlation data is generated by taking a logarithm, such as log base 10, of the ratio of the total number of source channels over the selection criteria. In this way, the selection criteria can be used to weight against the number of page views in a way that works over a large numerical range of page views, source channels, and source attributes.

At operation 650, the selection correlation data may be stored in the database 126 using the database engine 250.

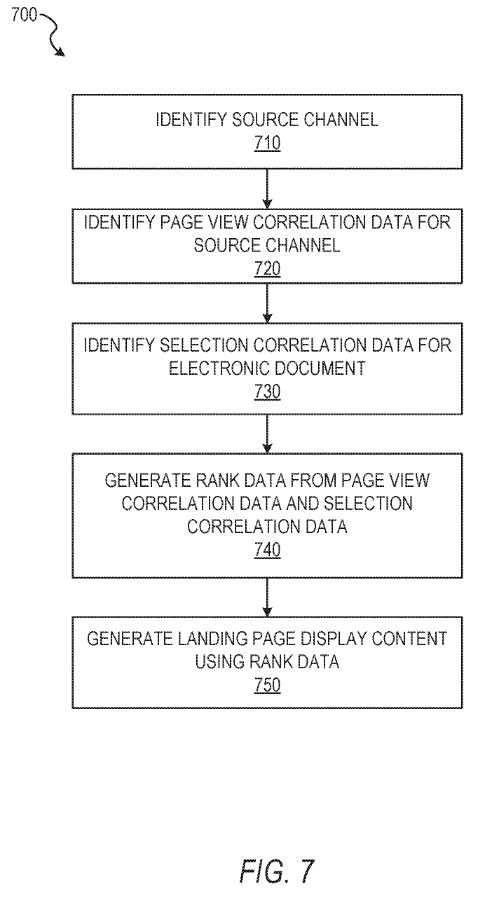

FIG. 7 is a flow chart 700 illustrating a method for generating rank data and landing page display content. The operations of FIG. 7 may be performed after the operations of FIG. 5 and FIG. 6; that is, for example, the page view correlation data may be generated and the selection correlation data may be generated before determining the rank data.

At operation 710, the source channel for a user on the landing page 302 is identified. The source channel is the channel or referring page that a user was on just before landing on the landing page 302. For example, the user 106 may be on source channel A, and then click on a hyperlink or network link that goes to the landing page 302. Thus, in that example, the identified source channel would be source channel A.

At operation 720, the page view correlation data generated by the page view engine 220 is identified or retrieved for the identified source channel. The page view correlation data may be generated and may correspond to 425 views for electronic document A, 3,214 views for electronic document B, and 5,471 views for electronic document C.

At operation 730, the rank engine 240 identifies selection correlation data for an available electronic document. For example, at operation 730 the rank engine 240 identifies a selection correlation for each of the electronic documents. With reference to FIG. 4, the selection correlation data for electronic document A is 0.94, the selection correlation data for electronic document B is 0.64, and the selection correlation data for electronic document C is 0.067.

At operation 740, the rank engine 240 uses the page view correlation data and the selection correlation data to generate rank data. In some embodiments, the rank engine 240 combines the page view correlation data and the selection correlation data by multiplying them to create source rank data per electronic document. In some embodiments, the rank engine 240 generates the rank data from the page view correlation data and the selection correlation data through other methods, such as multiplication, division, or other mathematical operations known to a person of ordinary skill in the art.

At operation 750, the rank data is used to sort the electronic documents based on the source rank value for each electronic document, and landing page content comprising the electronic documents sorted by source rank data is provided to the client device 110 for display. With reference to FIG. 3, in the display area 311, electronic document B has the highest source rank data, having a value of 2,060.10, followed by electronic A, which has a source rank data of 400.35, followed by electronic document C, which has a source rank value of 366.27.

Notably, the high page view value of electronic document C is attenuated by the number of users of the source channels that selected electronic document C, which indicates that electronic document C is likely broad in scope and not customized or highly relevant to any one of the source channels. Thus, again with reference to FIG. 3, electronic document C is put at the bottom of the list in the display area 311. Other documents not depicted may be sorted according to rank the same way. For example, every electronic document from electronic document A to electronic document N may be sorted against each other using source rank values.

FIG. 8A is an example of source channel A 800 implemented as a user interface within a browser 802, according to some embodiments. The browser 802 may be run from the client device 110, as the web client 112. As illustrated, source channel A 800 may be implemented as a NOSQL Database administrative dashboard. Though source channel A 800 is illustrated as an administrative dashboard, one of ordinary skill in the art appreciates that other types of source channels are possible. For example, a source channel may correspond to a search engine home page, a web-service platform home page, a help page, or a content page (e.g., blog page) that has links to any other webpage. In the last example embodiment, where the source channel is a blog page linking to any other page, the other pages would then be functional as a landing page, such as the landing page 302.

Source channel A 800 comprises three source attributes which are panels or landing modules within the dashboard. For example, source attribute A 804 may be implemented as a Node Balancer panel that monitors the balance of resources across nodes in a database cluster. Source attribute B 806 may be a cluster status panel that displays data for the cluster including computation of resources used per node. Further, source attribute C 808 may correspond to a user profile module that shows the NOSQL Database admin as Ford Prefect and further illustrates user data such as what administrator Ford Prefect's access privileges are (e.g., admin user), his username (e.g., FPREFECT123), and/or other user data (e.g., 101279). Administrator Ford Prefect may correspond to the user 106 in FIG. 1. When the user 106 clicks on one of the source attributes or any other link within source channel A 800, the client device 110 upon which the user 106 is running the database dashboard may send a request to the application server(s) 140 for a landing page 302.

The operations illustrated in FIG. 5, FIG. 6, and FIG. 7 may be performed by a back-end server such as the application server(s) 140 that comprises the source feature content generator 142. The source feature content generator 142 may determine the page view correlation data, the selection correlation data, and the rank data for each of the possible electronic documents within the landing page 302 and display them according to rank data as discussed above.

For example, FIG. 8B shows an example of the landing page 302 displayed within the browser 802. In this example, the user 106 has clicked on source attribute C 808, which is the user profile module. in response to the click, the application server 140 has generated the landing page 302 comprising request results 812, 814, and 816 within a display area 311.

Each of the request results 812, 814, and 816 may correspond respectively to an electronic document such as electronic document A, electronic document B, and electronic document C. For example, in some embodiments, the request results 812, 814, and 816 may each comprise portions of the electronic document that each links to. In some embodiments, the request results 812, 814, and 816 are electronic documents displayed directly within the landing page 302 or through one or more frames (e.g., iframes).

As explained above with reference to FIG. 4, the request result 816 is a FAQ page that may have a high page count with respect to source channel A, but selection correlation data attenuates the value of the page view and source rank value for the request result 816. Accordingly, the request result 816 is sorted to a lower position within the display area 311.

In some embodiments, the source attributes may be used to further refine the source channel and resulting rank data. For example, as discussed with reference to FIG. 4, the number of page views of electronic document A from source channel A 800 is 425. However, the number of page views of electronic document A from a user on source channel A 800, and further from a user that specifically clicked on source attribute C 808 may have a different value, such as 43 page views. Thus, in rank data A (FIG. 4) the page view correlation data may be 43, not 425 (e.g., “pv_sourceA: 43”), Accordingly in some embodiments, the source channel comprises a referring webpage (e.g., a webpage that network links to landing page 302), and additional dimensions or attributes that further specify the “source” or origin of a user on the landing page 302.

Similarly, the selection correlation data may also be refined using source attributes. For example, assume that each of the 35 source channels in FIG. 4 has three source attributes (e.g., each of the 35 source channels is a webpage having three modules or links, as in FIG. 8A) in this case, there can be 105 source channels available and the numerator may be 105 instead of 35. The historical selection criteria can then be the number of users that followed a network source feature path from a given source attribute of a source channel to the electronic document. That is, of the available 105 source channels and source attributes, how many navigated to electronic document A, for example.

The generation of source rank data per electronic document may be performed as above: by multiplying the multidimensional page view correlation data (which is now based on source channel and attribute) by the multidimensional selection correlation data (which is also now based on source channel and attribute).

In some embodiments, the source attributes may correspond to data that is associated with source channel A, but not necessarily displayed within a user interface or as a clickable link. For example, if the user 106 clicks on a “Help” hyperlink 803, the interface engine 210 may interface with the system 150 to determine what type of user is logged in, customer or database administrator. After determining that a “database administrator” is logged in, the page view engine 220 may determine how many page views of electronic document A originated from source channel A 800 having a source attribute of “database administrator”.

Similarly, non-depicted data can be used as source attributes in addition to depicted data. For example, if the user 106 clicks on source attribute A 804, the interface engine 210 may also identify that the user 106 is a database administrator. Page view correlation data may then be ascertained by determining how many page views of electronic document A originated from source channel A 800, by a user clicking source attribute A 804 (the node balancer panel), and further by a user having database administrator access. The selection correlation data and source rank data may be similarly analyzed. In this way, electronic documents are sorted based on network path features (source channel, or source channel and attributes) to automatically generate sorted content for display within the display area 311.

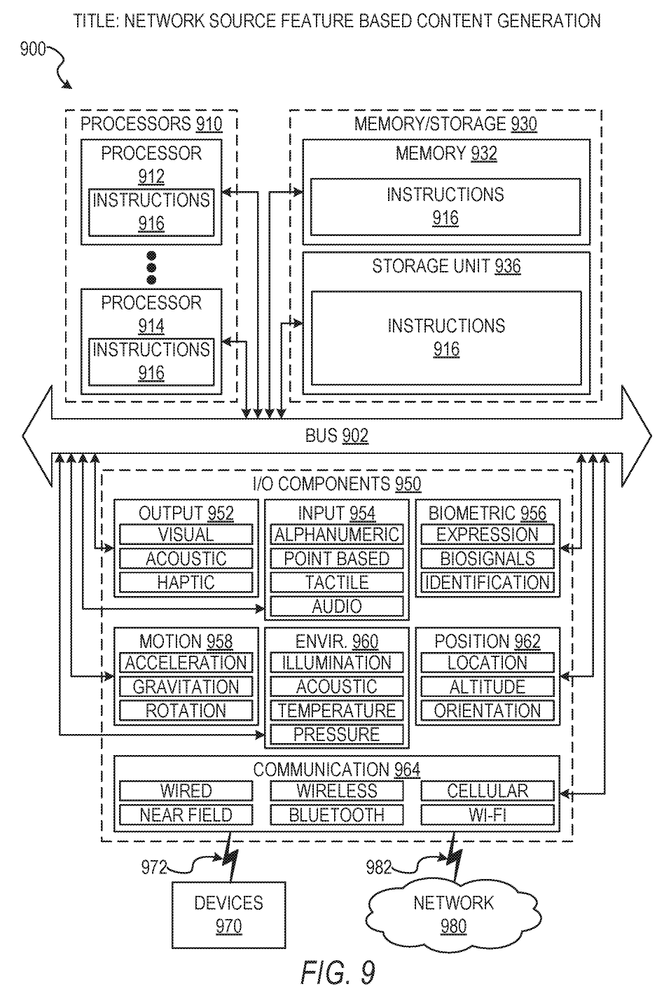

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein can be executed. For example, the instructions 916 can cause the machine 900 to execute the flow diagrams of FIGS. 5-7. Additionally, or alternatively, the instructions 916 can implement the interface engine 210, page view engine 220, selection engine 230, rank engine 240, database engine 250, and display engine 260 of FIG. 2, and so forth. The instructions 916 transform the general, non-programmed machine into a particular machine programmed to carry out the described and illustrated functions in the manner described. In alternative embodiments, the machine 900 operates as a standalone device or can be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 can include processors 910, memory/storage 930, and I/O components 950, which can be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, a processor 912 and a processor 914 that may execute the instructions 916. The term “processor” is intended to include multi-core processor that may comprise two or more independent processors (sometimes referred to as “cores”) that can execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory/storage 930 can include a memory 932, such as a main memory, or other memory storage, and a storage unit 936, both accessible to the processors 910 such as via the bus 902. The storage unit 936 and memory 932 store the instructions 916 embodying any one or more of the methodologies or functions described herein. The instructions 916 can also reside, completely or partially, within the memory 932, within the storage unit 936, within at least one of the processors 910 (e.g., within the processor's cache memory), or any suitable combination thereof, during execution thereof by the machine 900. Accordingly, the memory 932, the storage unit 936, and the memory of the processors 910 are examples of machine-readable media.

As used herein, the term “machine-readable medium” means a device able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store the instructions 916. The term “machine-readable medium” shall also be taken to include any medium, or combination of multiple media, that is capable of storing instructions (e.g., instructions 916) for execution by a machine (e.g., machine 900), such that the instructions, when executed by one or more processors of the machine (e.g., processors 910), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 950 can include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 can include many other components that are not shown in FIG. 9. The I/O components 950 are grouped according to functionality merely for simplifying the following discussion, and the grouping is in no way limiting. In various example embodiments, the I/O components 950 can include output components 952 and input components 954. The output components 952 can include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 can include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In further example embodiments, the I/O components 950 can include biometric components 956, motion components 958, environmental components 960, or position components 962 among a wide array of other components. For example, the biometric components 956 can include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 can include acceleration sensor components (e.g., an accelerometer), gravitation sensor components, rotation sensor components (e.g., a gyroscope), and so forth. The environmental components 960 can include, for example, illumination sensor components (e.g., a photometer), temperature sensor components (e.g., one or more thermometers that detect ambient temperature), humidity sensor components, pressure sensor components (e.g., a barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 962 can include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 950 may include communication components 964 operable to couple the machine 900 to a network 980 or devices 970 via a coupling 982 and a coupling 972, respectively. For example, the communication components 964 include a network interface component or other suitable device to interface with the network 980. In further examples, the communication components 964 include wired communication components, wireless communication components, cellular communication components, Near Field Communication (NFC) components, BLUETOOTH® components (e.g., BLUETOOTH® Low Energy), WI-FI® components, and other communication components to provide communication via other modalities. The devices 970 may be another machine or any of a wide variety of peripheral devices (e.g., a peripheral device coupled via a Universal Serial Bus (USB)).

Moreover, the communication components 964 can detect identifiers or include components operable to detect identifiers. For example, the communication components 964 can include Radio Frequency Identification (REID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced. Space Symbology (UCC RSS)-2D bar codes, and other optical codes), acoustic detection components (e.g., microphones to identify tagged audio signals), or any suitable combination thereof. In addition, a variety of information can be derived via the communication components 964, such as location via Internet Protocol (IP) geolocation, location via WI-FI® signal triangulation, location via detecting a BLUETOOTH® or NFC beacon signal that may indicate a particular location, and so forth.

In various example embodiments, one or more portions of the network 980 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a WI-FI® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or other type of cellular or wireless coupling. In this example, the coupling 982 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UNITS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 916 can be transmitted or received over the network 980 using a transmission medium via a network interface device (e.g., a network interface component included in the communication components 964) and utilizing any one of a number of well-known transfer protocols (e.g., Hypertext Transfer Protocol (HTTP)). Similarly, the instructions 916 can be transmitted or received using a transmission medium via the coupling 972 (e.g., a peer-to-peer coupling) to the devices 970. The term “transmission medium” shall be taken to include any intangible medium that is capable of storing, encoding, or carrying the instructions 916 for execution by the machine 900, and includes digital or analog communications signals or other intangible media to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A computer-implemented method comprising:
receiving, from a user, a request for a landing page to display on a client device of the user, the landing page comprising a display area for a plurality of electronic documents;
identifying a plurality of source channels that refer to the landing page through a network link;
determining a page view correlation between the plurality of electronic documents and the plurality of source channels;
determining a selection correlation between the plurality of electronic documents and the plurality of source channels;
generating a context rank based on the page view correlation and the selection correlation; and
generating request results for display in the display area, the request results displaying the plurality of electronic documents based on the context rank.

2. The computer-implemented method of claim 1, wherein the page view correlation corresponds to a number of page views for an electronic document of the plurality of electronic documents caused by a source channel of the plurality of source channels using the network link.

3. The computer-implemented method of claim 1, wherein the selection correlation corresponds to a number of source channels of the plurality of source channels and a number of electronic documents of the plurality of electronic documents that have been selected from the landing page.

4. The computer-implemented method of claim 1, wherein determining the page view correlation, determining the selection correlation, and generating the context rank are performed in response to receiving the request from the user.

5. The computer-implemented method of claim 1, wherein determining the page view correlation, determining the selection correlation, and generating the context rank are performed before receiving the request from the user.

6. The computer-implemented method of claim 1, wherein the plurality of source channels correspond to a plurality of source pages and the network link is a hyperlink.

7. The computer-implemented method of claim 1, further comprising:
identifying one or more source attributes of the plurality of source channels; and
wherein the page view correlation is determined based on the one or more source attributes, and the selection correlation is determined based on the one or more source attributes.

8. A system for managing electronic documents, the system comprising:
one or more processors of a machine; and
a memory storing instructions that, when executed by the one or more processors, cause the machine to at least:
receive, from a user, a request for a landing page to display on a client device of the user, the landing page comprising a display area for a plurality of electronic documents;
identify a plurality of source channels that refer to the landing page through a network link;
determine a page view correlation between the plurality of electronic documents and the plurality of source channels;
determine a selection correlation between the plurality of electronic documents and the plurality of source channels;
generate a context rank based on the page view correlation and the selection correlation; and
generate request results for display in the display area, the request results displaying the plurality of electronic documents based on the context rank.

9. The system of claim 8, wherein the page view correlation corresponds to a number of page views for an electronic document of the plurality of electronic documents caused by a source channel of the plurality of source channels using the network link.

10. The system of claim 8, wherein the selection correlation corresponds to a number of source channels of the plurality of source channels and a number of electronic documents of the plurality of electronic documents that have been selected from the landing page.

11. The system of claim 8, wherein determining the page view correlation, determining the selection correlation, and generating the context rank are performed in response to receiving the request from the user.

12. . The system of claim 8, wherein determining the page view correlation, determining the selection correlation, and generating the context rank are performed before receiving the request from the user.

13. The system of claim 8, wherein the plurality of source channels correspond to a plurality of source pages and the network link is a hyperlink.

14. The system of claim 8, wherein the instructions further cause the machine to:
identify one or more source attributes of the plurality of source channels; and
wherein the page view correlation is determined based on the one or more source attributes, and the selection correlation is determined based on the one or more source attributes.

15. A non-transitory computer-readable storage medium embodying instructions that, when executed by a machine, cause the machine to perform operations comprising:
receiving, from a user, a request for a landing page to display on a client device of the user, the landing page comprising a display area for a plurality of electronic documents;
identifying a plurality of source channels that refer to the landing page through a network link;
determining a page view correlation between the plurality of electronic documents and the plurality of source channels;
determining a selection correlation between the plurality of electronic documents and the plurality of source channels;
generating a context rank based on the page view correlation and the selection correlation; and
generating request results for display in the display area, the request results displaying the plurality of electronic documents based on the context rank.

16. The computer-readable storage medium of claim 15, wherein the page view correlation corresponds to a number of page views for an electronic document of the plurality of electronic documents caused by a source channel of the plurality of source channels using the network link.

17. The computer-readable storage medium of claim 15, wherein the selection correlation corresponds to a number of source channels of the plurality of source channels and a number of electronic documents of the plurality of electronic documents that have been selected from the landing page.

18. The computer-readable storage medium of claim 15, wherein determining the page view correlation, determining the selection correlation, and generating the context rank are performed in response to receiving the request from the user.

19. The computer-readable storage medium of claim 15, wherein determining the page view correlation, determining the selection correlation, and generating the context rank are performed before receiving the request from the user.

20. The computer-readable storage medium of claim 15, wherein the instructions further cause the machine to perform operations comprising:
identifying one or more source attributes of the plurality of source channels; and
wherein the page view correlation is determined based on the one or more source attributes, and the selection correlation is determined based on the one or more source attributes.
